(19) United States
(12) Patent Application Publication
(10) Pub. No.: US 2025/0310907 A1
(43) Pub. Date: Oct. 2, 2025

(54) MEASUREMENT METHOD AND APPARATUS, AND DEVICE AND STORAGE MEDIUM

(71) Applicant: Beijing Xiaomi Mobile Software Co., Ltd., Beijing (CN)

(72) Inventors: Ziquan HU, Beijing (CN); Xuhua TAO, Beijing (CN)

(73) Assignee: Beijing Xiaomi Mobile Software Co., Ltd., Beijing (CN)

(21) Appl. No.: 18/865,974

(22) PCT Filed: May 20, 2022
(86) PCT No.: PCT/CN2022/094254

§ 371 Date: Nov. 14, 2024

(51) Int. Cl. H04W 56/00; H04L 5/00; H04W 24/10

(52) U.S. Cl. CPC H04W 56/0015; H04L 5/0051; H04W 24/10

(57) ABSTRACT

A measurement method, includes: determining measurement configuration information; and transmitting the measurement configuration information to user equipment; where the measurement configuration information includes measurement object information and measurement gap configuration information, and the measurement object information indicates that a reference signal to be measured by the user equipment includes a cell defining synchronization signal block (CD-SSB) and a non-cell defining synchronization signal block (NCD-SSB).

### CROSS REFERENCE TO RELATED APPLICATIONS

The application is a U.S. National Stage of International Application No. PCT/CN2022/094254, filed on May 20, 2022, the contents of all of which are incorporated herein by reference in their entirety for all purposes.

### BACKGROUND OF THE INVENTION

Time-frequency domain positions can be flexibly configured by the next generation node B (gNB) for transmitting various synchronization signal blocks (primary synchronization signal/secondary synchronization signal (PSS/SSS) physical broadcast channel (PBCH) blocks (SSBs for short)). The SSBs transmitted in different frequency positions can vary in physical cell identification (PCI). When associated with the remaining minimum system information (RMSI), that is, a system information block (SIB) 1, the SSB is referred to as a cell defining SSB (CD-SSB).

### SUMMARY OF THE INVENTION

The disclosure provides a measurement method and apparatus, a device, and a storage medium.

According to a first aspect of examples of the disclosure, a measurement method is provided. The measurement method is performed by a network device, and includes:
determining measurement configuration information; and
transmitting the measurement configuration information to user equipment; where
the measurement configuration information includes measurement object information and measurement gap configuration information, and the measurement object information indicates that a reference signal to be measured by the user equipment includes a cell defining synchronization signal block (CD-SSB) and a non-cell defining synchronization signal block (NCD-SSB).

According to a second aspect of the examples of the disclosure, a measurement method is provided. The measurement method is performed by user equipment, and includes:
receiving measurement configuration information transmitted by a network device; where
the measurement configuration information includes measurement object information and measurement gap configuration information, and the measurement object information indicates that a reference signal to be measured by the user equipment includes a cell defining synchronization signal block (CD-SSB) and a non-cell defining synchronization signal block (NCD-SSB).

According to a third aspect of the examples of the disclosure, a communication apparatus is provided. The communication apparatus includes:
a processor; and
a memory configured to store a processor-executable instruction; where
the processor is configured to implement steps of the measurement method in the first aspect described above by executing the executable instruction in the memory.

According to a fourth aspect of the examples of the disclosure, a communication apparatus is provided. The communication apparatus includes:
a processor; and
a memory configured to store a processor-executable instruction; where
the processor is configured to implement steps of the measurement method in the second aspect described above by executing the executable instruction in the memory.

According to a fifth aspect of the examples of the disclosure, a non-transitory computer-readable storage medium is provided. The non-transitory computer-readable storage medium stores an instruction, where when the instruction is called to be executed on a computer, the computer is caused to execute steps of the measurement method described above.

It should be understood that the foregoing general description and the following detailed description are merely illustrative and explanatory, and cannot limit the disclosure.

### BRIEF DESCRIPTION OF DRAWINGS

Accompanying drawings described here are used for providing further understanding of examples of the disclosure as a constituent part of the disclosure. Schematic examples of the disclosure and their descriptions are used to explain the examples of the disclosure, rather than constitute improper limitation to the examples of the disclosure. In the figures:

The accompanying drawings here are incorporated into the description as a constituent part of the description, illustrate examples conforming to the disclosure, and serve to explain principles of the example of the disclosure along with the description.

FIG. 1 is a schematic architecture diagram of a radio communication system according to an illustrative example;

FIG. 2 is a flowchart of a measurement method according to an illustrative example;

FIG. 3 is a flowchart of a measurement method according to an illustrative example;

FIG. 4 is a schematic diagram of a measurement gap length according to an illustrative example;

FIG. 5 is a flowchart of a measurement method according to an illustrative example;

FIG. 6 is a schematic diagram of a measurement gap length according to an illustrative example;

FIG. 7 is a flowchart of a measurement method according to an illustrative example;

FIG. 8 is a flowchart of a measurement method according to an illustrative example;

FIG. 9 is a flowchart of a measurement method according to an illustrative example;

FIG. 10 is a block diagram of a measurement apparatus according to an illustrative example;

FIG. 11 is a block diagram of a measurement apparatus according to an illustrative example;

FIG. 12 is a structural diagram of a measurement apparatus according to an illustrative example; and

FIG. 13 is a structural diagram of a measurement apparatus according to an illustrative example.

### DETAILED DESCRIPTION OF THE INVENTION

Examples of the disclosure will be further described with reference to accompanying drawings and in conjunction with specific embodiments.

Illustrative examples will be described in detail here, and their instances are shown in the accompanying drawings. When the following description involves the accompanying drawings, the same numerals in different accompanying drawings indicate the same or similar elements unless otherwise indicated. Embodiments described in the following illustrative examples do not denote all embodiments consistent with the examples of the disclosure. On the contrary, these embodiments are merely instances of apparatuses and methods consistent with some aspects of the disclosure as detailed in the appended claims.

Terms used in the examples of the disclosure are merely used for describing specific examples rather than limiting the examples of the disclosure. Singular forms such as “a/an” and “this” used in the examples and the appended claims of the disclosure are also intended to include plural forms, unless otherwise clearly stated in the context. It should also be understood that the term “and/or” used here indicates and includes any or all possible combinations of one or more of associated listed items.

It should be understood that although terms such as first, second and third can be used in the examples of the disclosure to describe different types of information, the information should not be limited to these terms. These terms are merely used for distinguishing the same type of information from each other. For example, first information can also be referred to as second information and second information can also be referred to as first information similarly without departing from the scope of examples of the disclosure. Depending on the context, the word “if” as used here can be interpreted as “at the time of” or “when” or “in response to determining”.

The examples of the disclosure are described in detail below, and instances of the examples are shown in the accompanying drawings, throughout which identical or similar reference numerals indicate identical or similar elements. The examples described below with reference to the accompanying drawings are illustrative and are intended to explain the disclosure, but should not be construed as limitation to the disclosure. Based on an existing protocol, the CD-SSB is generally used by a terminal for measuring SSB-based relevant radio resource management (RRM). The CD-SSB is configured for the terminal through a measurement object (MeasObject), a parameter of radio resource control (RRC).

The 3^{rd} generation partnership project (3GPP) introduces a type of reduced capability (RedCap) terminal in release 17 (Rel-17), which features low cost, low complexity and small size. Compared with an enhanced mobile BroadBand (eMBB) terminal, the RedCap terminal has a reduced bandwidth, with a frequency range 1 (FR1) reduced to 20 MHz and a frequency range 2 (FR2) reduced to 100 MHz. Since the bandwidth of the RedCap terminal is limited, possibly no CD-SSB exists in the bandwidth. At present, the RedCap terminal is authorized to perform measurement based on a non-cell defining SSB (NCD-SSB) according to the 3GPP.

On this basis, the disclosure related to the technical field of radio communication, provides a measurement method and apparatus, a device, and a storage medium.

As shown in FIG. 1, a measurement method according to the example of the disclosure may be performed by a radio communication system 100. The radio communication system 100 may include, but is not limited to, a network device 101 and user equipment 102. The user equipment 102 is configured to support carrier aggregation, and the user equipment 102 may be connected to a plurality of carrier units of the network device 101 including a primary carrier unit and one or more secondary carrier units.

It should be understood that the radio communication system 100 may be applied to a low-frequency scenario and a high-frequency scenario. The application scenarios of the radio communication system 100 include, but are not limited to, a long term evolution (LTE) system, an LTE frequency division duplex (FDD) system, an LTE time division duplex (TDD) system, a worldwide interoperability for micro wave access (WiMAX) communication system, a cloud radio access network (CRAN) system, a future 5th-generation (5G) system, a new radio (NR) communication system, a future evolved public land mobile network (PLMN) system, etc.

The user equipment 102 may be user equipment (UE), a terminal, an access terminal, a terminal unit, a terminal station, a mobile station (MS), a remote station, a remote terminal, a mobile terminal, a radio communication device, a terminal agent or user device. The user equipment 102 may have a radio transmitting and receiving function, and may communicate (for example, in a wireless mode) with one or more network devices 101 of one or more communication systems and receive a network service provided by the network device 101. The network device 101 here includes, but is not limited to, a base station shown in the figure.

The user equipment 102 may be a cellular phone, a cordless phone, a session initiation protocol (SIP) phone, a wireless local loop (WLL) station, a personal digital assistant (PDA) device, a handheld device with a radio communication function, a computation device or other processing devices connected to a radio modem, a vehicle-mounted device, a wearable device, user equipment in a future 5G network, user equipment in a future evolved PLMN, etc.

The network device 101 may be an access network device (or referred to as an access network site). The access network device refers to a device that provides a network access function, such as a radio access network (RAN) base station. The network device 101 may specifically include a base station (BS) device, or a base station device and a radio resource management device for controlling the base station. The network device 101 may also include a relay station (relay device), an access point, a base station in the future 5G network, a base station in the future evolved PLMN, or a NR base station. The network device 101 may be a wearable device or a vehicle-mounted device. The network device 101 may also be a communication chip with a communication module.

For example, the network device 101 includes, but is not limited to, gnodeB (gNB), an evolved node B (eNB) in the LTE system, a radio network controller (RNC), a node B (NB) in a wideband code division multiple access (WCDMA) system, a radio controller in a centralized radio access network (CRAN) system, a base station controller (BSC), a base transceiver station (BTS) in a global system for mobile communications (GSM) or a code division multiple access (CDMA) system, a home base station (for example, a home evolved nodeB, or a home node B (HNB)), a baseband unit (BBU), a transmitting and receiving point (TRP), a transmitting point (TP), a mobile switching center, etc. in 5G.

For the same cell, the same ssb-PositionsInBurst, PCI, ssb-periodicity, ssb-PBCH-BlockPower, etc. are configured for a non-cell defining synchronization signal block (NCD-SSB) and a cell defining synchronization signal block (CD-SSB) that are used for measurement. The NCD-SSB and the CD-SSB that have the same SSBindex are of quasi-co-location (QCL).

A transmission time difference is configured between the CD-SSB and the NCD-SSB for solving the possible power limitation problem.

The disclosure can be performed by a Redcap terminal, but is not limited to this, and can also be applied to other types of terminals.

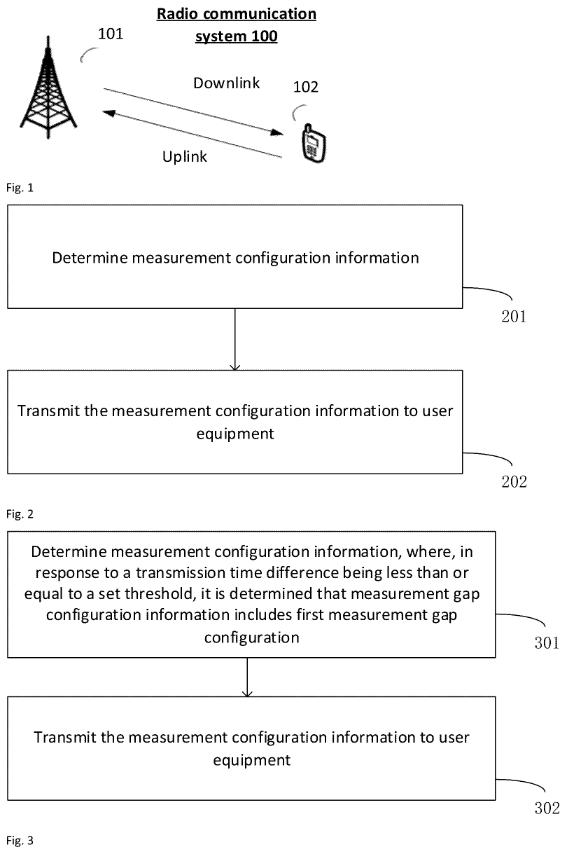

The example of the disclosure provides a measurement method. The method is performed by a network device. FIG. 2 is a flowchart of a measurement method according to an illustrative example. As shown in FIG. 2, the method includes:

Step 201, measurement configuration information is determined.

Step 202, the measurement configuration information is transmitted to user equipment.

The measurement configuration information includes measurement object information and measurement gap configuration information, and the measurement object information indicates that a reference signal to be measured by the user equipment includes a cell defining synchronization signal block (CD-SSB) and a non-cell defining synchronization signal block (NCD-SSB).

In an embodiment, the network device configures a measurement configuration parameter (MeasConfig) for the user equipment. That is, the network device determines the measurement configuration information. The measurement configuration information includes the measurement object information (MeasObject) and the measurement gap configuration information (MeasGapConfig). The measurement object information includes two measurement objects, one measurement object indicates a reference signal CD-SSB to be measured, and the other measurement object indicates a reference signal NCD-SSB to be measured. The measurement gap configuration information includes one set of measurement gap configuration or two sets of measurement gap configuration for measuring the CD-SSB and the NCD-SSB. Each set of measurement gap configuration indicates a corresponding measurement gap length, measurement gap period and measurement gap offset. Moreover, the measurement gap configuration information is determined based on the measurement object information. After determining the measurement configuration information, the network device transmits the measurement configuration information to the user equipment, and the user equipment measures the reference signal CD-SSB and the reference signal NCD-SSB based on the measurement configuration information received.

It should be noted that the measurement object indicates the reference signal to be measured, and further indicates a frequency point corresponding to the reference signal and transmission duration of the reference signal.

In an embodiment, the measurement gap configuration information indicates the measurement gap length, and the measurement gap length is determined by the network device based on a transmission time difference between the CD-SSB and the NCD-SSB. It should be noted that when transmitting the CD-SSB and the NCD-SSB, the network device may configure a transmission time difference between the CD-SSB and the NCD-SSB for solving the possible power limitation problem. Thus, the network device knows the transmission time difference between the CD-SSB and the NCD-SSB. The transmission time difference between the CD-SSB and the NCD-SSB refers to a gap between initial transmission moments of the CD-SSB and the NCD-SSB.

In the embodiment described above, in a scenario where the reference signal to be measured includes the CD-SSB and the NCD-SSB, a solution where the CD-SSB and the NCD-SSB coexist is needed for measuring radio resource management (RRM). The measurement method according to the disclosure is applied to a scenario where the CD-SSB and the NCD-SSB coexist, and expands an application scenario of radio resource management (RRM) measurement.

The example of the disclosure provides a measurement method. The method is performed by a network device. The method may be performed independently or in combination with any other example of the examples of the disclosure. FIG. 3 is a flowchart of a measurement method according to an illustrative example. As shown in FIG. 3, the method includes:

Step 301, measurement configuration information is determined. A measurement gap length is determined based on a transmission time difference between a CD-SSB and a NCD-SSB. In response to determining that the transmission time difference is less than or equal to a set threshold, it is determined that measurement gap configuration information includes first measurement gap configuration.

Step 302, the measurement configuration information is transmitted to user equipment.

The measurement configuration information includes measurement object information and the measurement gap configuration information, and the measurement object information indicates that a reference signal to be measured by the user equipment includes a cell defining synchronization signal block (CD-SSB) and a non-cell defining synchronization signal block (NCD-SSB).

In addition, the first measurement gap configuration is configured for the user equipment to measure the CD-SSB and the NCD-SSB.

In an embodiment, the network device configures a measurement configuration parameter for the user equipment. That is, the network device determines the measurement configuration information. The measurement configuration information includes the measurement object information and the measurement gap configuration information. The measurement object information includes two measurement objects, one measurement object indicates a reference signal CD-SSB to be measured, and the other measurement object indicates a reference signal NCD-SSB to be measured. The measurement gap configuration information includes measurement gap configuration. The measurement gap configuration indicates a corresponding measurement gap length, measurement gap period and measurement gap offset. The measurement gap length is determined based on the transmission time difference between the CD-SSB and the NCD-SSB. Specifically, in response to determining that the transmission time difference is less than or equal to the set threshold, it is determined that the measurement gap configuration information includes the first measurement gap configuration. After determining the measurement configuration information, the network device transmits the measurement configuration information to the user equipment. After receiving the measurement configuration information, the user equipment measures the reference signal CD-SSB and the reference signal NCD-SSB based on a first measurement gap length, a first measurement gap period and a first measurement gap offset that are indicated by the first measurement gap configuration.

The set threshold may be set by the network device or agreed by a communication protocol.

As shown in FIG. 4, the user equipment measures the reference signal CD-SSB 40 and the reference signal NCD-SSB 41 within the same measurement gap.

In an embodiment, the measurement object information includes two measurement objects. One measurement object indicates the reference signal CD-SSB 40 to be measured, a frequency point corresponding to the CD-SSB, and transmission duration 45 of the CD-SSB. The other measurement object indicates the reference signal NCD-SSB 41 to be measured, a frequency point corresponding to the NCD-SSB and transmission duration 43 of the NCD-SSB. When the transmission time difference 44 between the CD-SSB 40 and the NCD-SSB 41 is less than or equal to the set threshold, it is determined that the CD-SSB 40 and the NCD-SSB 41 are measured with a set of measurement gap configuration, that is, the first measurement gap configuration. This first measurement gap configuration indicates the first measurement gap length 42. The first measurement gap length 42 is greater than a sum of the transmission duration 45 of the CD-SSB, the transmission duration 43 of the NCD-SSB and the transmission time difference 44 between the CD-SSB 40 and the NCD-SSB 41, as shown in FIG. 4. The transmission duration 45 of the CD-SSB and the transmission duration 43 of the NCD-SSB are shown in FIG. 4, and are equal to the duration for transmitting the reference signal by the network device.

In the embodiment described above, in a scenario where the reference signal to be measured includes the CD-SSB and the NCD-SSB, a solution where the CD-SSB and the NCD-SSB coexist is needed for measuring radio resource management (RRM). The measurement method according to the disclosure is applied to a scenario where the CD-SSB and the NCD-SSB coexist, and expands an application scenario of radio resource management (RRM) measurement.

The example of the disclosure provides a measurement method. The method is performed by a network device. The method may be performed independently or in combination with any other example of the examples of the disclosure. FIG. 5 is a flowchart of a measurement method according to an illustrative example. As shown in FIG. 5, the method includes:

Step 501, measurement configuration information is determined. A measurement gap length is determined based on a transmission time difference between a CD-SSB and a NCD-SSB. In response to determining that the transmission time difference is greater than a set threshold, it is determined that measurement gap configuration information includes second measurement gap configuration and third measurement gap configuration.

Step 502, the measurement configuration information is transmitted to user equipment.

The measurement configuration information includes measurement object information and the measurement gap configuration information, and the measurement object information indicates that a reference signal to be measured by the user equipment includes a cell defining synchronization signal block (CD-SSB) and a non-cell defining synchronization signal block (NCD-SSB).

The second measurement gap configuration is configured for the user equipment to measure the CD-SSB, and the third measurement gap configuration is configured for the user equipment to measure the NCD-SSB.

In an embodiment, the network device configures a measurement configuration parameter for the user equipment. That is, the network device determines the measurement configuration information. The measurement configuration information includes the measurement object information and the measurement gap configuration information. The measurement object information includes two measurement objects, one measurement object indicates a reference signal CD-SSB to be measured, and the other measurement object indicates a reference signal NCD-SSB to be measured. The measurement gap configuration information includes measurement gap configuration. The measurement gap configuration indicates a corresponding measurement gap length, measurement gap period and measurement gap offset. The measurement gap length is determined based on the transmission time difference between the CD-SSB and the NCD-SSB. Specifically, it is determined that in response to determining that the transmission time difference is greater than the set threshold, the measurement gap configuration information includes the second measurement gap configuration and the third measurement gap configuration. After determining the measurement configuration information, the network device transmits the measurement configuration information to the user equipment.

After receiving the measurement configuration information, the user equipment measures the reference signal CD-SSB based on a second measurement gap length, a second measurement gap period and a second measurement gap offset that are indicated by the second measurement gap configuration and measures the reference signal NCD-SSB based on a third measurement gap length, a third measurement gap period and a third measurement gap offset that are indicated by the third measurement gap configuration. That is, when the transmission time difference between the CD-SSB and the NCD-SSB is greater than the set threshold, the network device configures measurement gap configuration respectively for measuring the CD-SSB and the NCD-SSB.

It should be noted that when the transmission time difference between the CD-SSB and the NCD-SSB is less than or equal to the set threshold, that is, the transmission time difference between the CD-SSB and the NCD-SSB is small, the transmission time difference may be used for switching from measuring the NCD-SSB to measuring the CD-SSB when the user equipment measures the CD-SSB and the NCD-SSB within one measurement gap, thus waste of too much extra time due to the transmission time difference is avoided. However, when the transmission time difference between the CD-SSB and the NCD-SSB is greater than the set threshold, that is, the transmission time difference between the CD-SSB and the NCD-SSB is great, waiting for a long time is still needed due to the great transmission time difference after switching from measuring the NCD-SSB to measuring the CD-SSB is completed if the user equipment measures the CD-SSB and the NCD-SSB within one measurement gap, resulting in time waste. Thus, when the transmission time difference between the CD-SSB and the NCD-SSB is greater than the set threshold, the measurement gap configuration is configured respectively for measuring the CD-SSB and the NCD-SSB.

The set threshold may be set by the network device or agreed by a communication protocol.

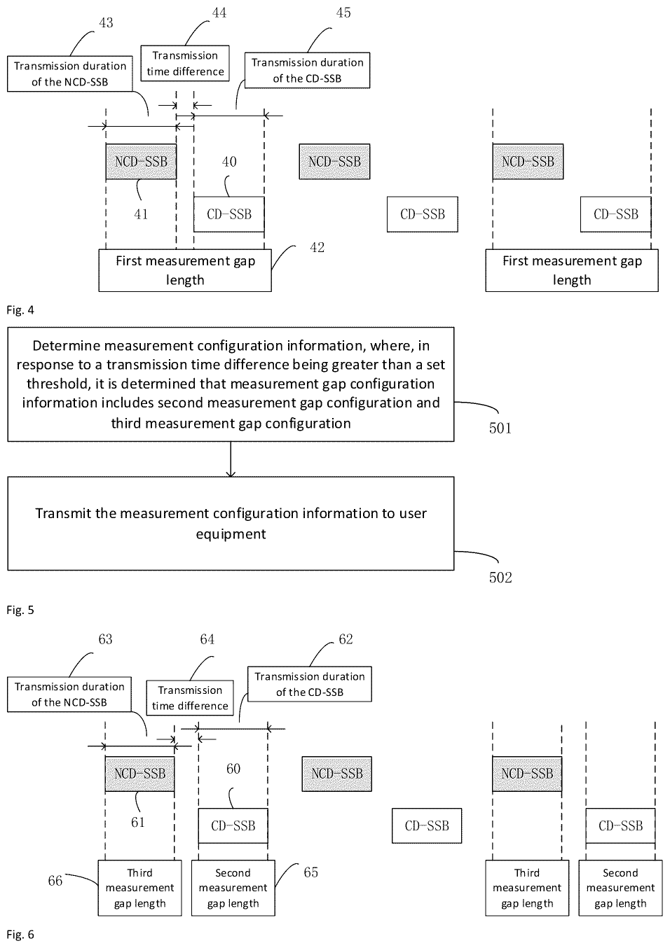

As shown in FIG. 6, the user equipment measures the reference signal CD-SSB 60 and the reference signal NCD-SSB 61 within two different measurement gaps respectively.

In an embodiment, the measurement object information includes two measurement objects. One measurement object indicates the reference signal CD-SSB 60 to be measured, a frequency point corresponding to the CD-SSB, and transmission duration 62 of the CD-SSB. The other measurement object indicates the reference signal NCD-SSB 61 to be measured, a frequency point corresponding to the NCD-SSB and transmission duration 63 of the NCD-SSB. When the transmission time difference 64 between the CD-SSB 60 and the NCD-SSB 61 is greater than the set threshold, it is determined that the CD-SSB 60 and the NCD-SSB 61 are measured with two sets of measurement gap configuration, that is, the second measurement gap configuration and the third measurement gap configuration respectively.

The second measurement gap configuration indicates the second measurement gap length 65, the second measurement gap period, and the second measurement gap offset. The third measurement gap configuration indicates the third measurement gap length 66, the third measurement gap period and the third measurement gap offset.

In an example, the second measurement gap length 65 is configured based on the transmission duration 62 of the CD-SSB. The third measurement gap length 66 is configured based on the transmission duration 63 of the NCD-SSB.

In an example, the second measurement gap length 65 is equal to the third measurement gap length 66, as shown in FIG. 6. The measurement gap length is duration for measuring the reference signal by the user equipment.

In an example, the second measurement gap period is equal to the third measurement gap period, and a difference between the second measurement gap offset and the third measurement gap offset is equal to the transmission time difference 64 between the CD-SSB and the NCD-SSB, as shown in FIG. 6. The measurement gap offset is an offset from a start position of the measurement period within the measurement period. For example, a first vertical dashed line numbered 1 in FIG. 6 denotes a start position of the measurement period for measurement of the NCD-SSB, and a second vertical dashed line numbered 2 is a start position of the measurement period for measurement of the CD-SSB. The third measurement gap offset for measurement of the NCD-SSB is 0, and the second measurement gap offset for measurement of the CD-SSB is equal to the transmission time difference 64 between the CD-SSB and the NCD-SSB, thus the difference between the second measurement gap offset and the third measurement gap offset is equal to the transmission time difference 64.

In the embodiment described above, in a scenario where the reference signal to be measured includes the CD-SSB and the NCD-SSB, a solution where the CD-SSB and the NCD-SSB coexist is needed for measuring radio resource management (RRM). The measurement method according to the disclosure is applied to a scenario where the CD-SSB and the NCD-SSB coexist, and expands an application scenario of radio resource management (RRM) measurement.

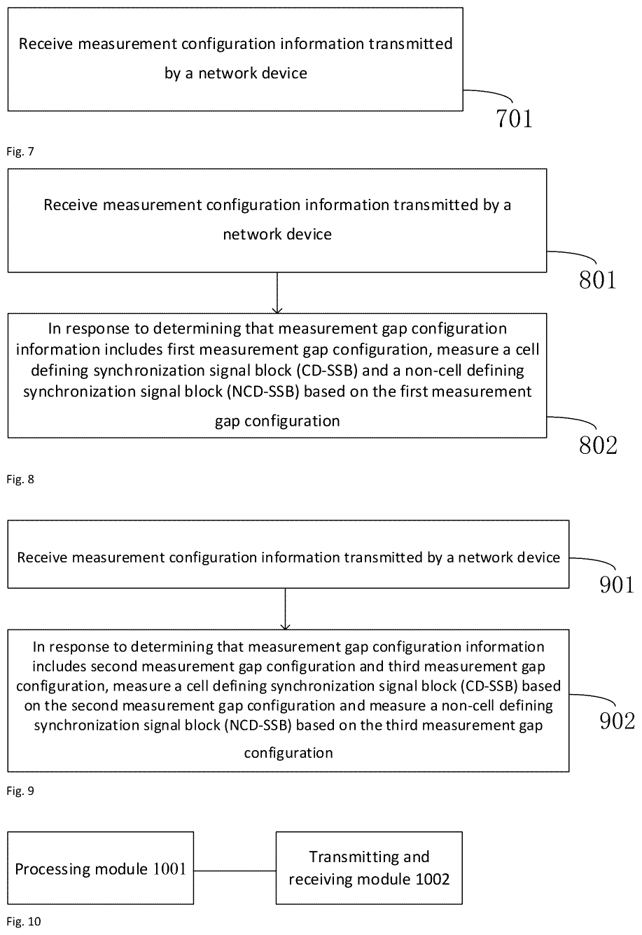

The example of the disclosure provides a measurement method. The method is performed by user equipment. FIG. 7 is a flowchart of a measurement method according to an illustrative example. As shown in FIG. 7, the method includes:

Step 701, measurement configuration information transmitted by a network device is received.

The measurement configuration information includes measurement object information and measurement gap configuration information, and the measurement object information indicates that a reference signal to be measured by the user equipment includes a cell defining synchronization signal block (CD-SSB) and a non-cell defining synchronization signal block (NCD-SSB).

In an embodiment, the network device configures a measurement configuration parameter (MeasConfig) for the user equipment. That is, the network device determines the measurement configuration information. The measurement configuration information includes the measurement object information (MeasObject) and the measurement gap configuration information (MeasGapConfig). The measurement object information includes two measurement objects, one measurement object indicates a reference signal CD-SSB to be measured, and the other measurement object indicates a reference signal NCD-SSB to be measured. The measurement gap configuration information includes one set of measurement gap configuration or two sets of measurement gap configuration for measuring the CD-SSB and the NCD-SSB. Each set of measurement gap configuration indicates a corresponding measurement gap length, measurement gap period and measurement gap offset. Moreover, the measurement gap configuration information is determined based on the measurement object information. The network device transmits the measurement configuration information to the user equipment, and the user equipment measures the reference signal CD-SSB and the reference signal NCD-SSB based on the measurement configuration information received.

It should be noted that the measurement object indicates the reference signal to be measured, and further indicates a frequency point corresponding to the reference signal and transmission duration of the reference signal.

In an embodiment, the measurement gap configuration information indicates a measurement gap length, and the measurement gap length is determined by the network device based on a transmission time difference between the CD-SSB and the NCD-SSB. It should be noted that when transmitting the CD-SSB and the NCD-SSB, the network device may configure a transmission time difference between the CD-SSB and the NCD-SSB for solving the possible power limitation problem.

In the embodiment described above, in a scenario where the reference signal to be measured includes the CD-SSB and the NCD-SSB, a solution where the CD-SSB and the NCD-SSB coexist is needed for measuring radio resource management (RRM). The measurement method according to the disclosure is applied to a scenario where the CD-SSB and the NCD-SSB coexist, and expands an application scenario of radio resource management (RRM) measurement.

The example of the disclosure provides a measurement method. The method is performed by user equipment. The method may be performed independently or in combination with any other example of the examples of the disclosure. FIG. 8 is a flowchart of a measurement method according to an illustrative example. As shown in FIG. 8, the method includes:

Step 801, measurement configuration information transmitted by a network device is received.

Step 802, in response to determining that measurement gap configuration information includes first measurement gap configuration, a CD-SSB and an NCD-SSB are measured based on the first measurement gap configuration.

The measurement configuration information includes measurement object information and measurement gap configuration information, and the measurement object information indicates that a reference signal to be measured by the user equipment includes a cell defining synchronization signal block (CD-SSB) and a non-cell defining synchronization signal block (NCD-SSB). A measurement gap length is determined based on a transmission time difference between the CD-SSB and the NCD-SSB.

In an embodiment, the network device configures a measurement configuration parameter for the user equipment. That is, the network device determines the measurement configuration information. The measurement configuration information includes the measurement object information and the measurement gap configuration information. The measurement object information includes two measurement objects, one measurement object indicates a reference signal CD-SSB to be measured, and the other measurement object indicates a reference signal NCD-SSB to be measured. The measurement gap configuration information includes measurement gap configuration. The measurement gap configuration indicates a corresponding measurement gap length, measurement gap period and measurement gap offset. The measurement gap length is determined based on the transmission time difference between the CD-SSB and the NCD-SSB. The network device transmits the measurement configuration information to the user equipment. The user equipment determines that the measurement configuration information received includes a set of measurement gap configuration, that is, the first measurement gap configuration, and measures the reference signal CD-SSB and the reference signal NCD-SSB based on a first measurement gap length, a first measurement gap period and a first measurement gap offset that are indicated by the first measurement gap configuration.

A set threshold may be set by the network device or agreed by a communication protocol.

As shown in FIG. 4, the user equipment measures the reference signal CD-SSB and the reference signal NCD-SSB within the same measurement gap.

In an embodiment, the measurement object information received by the user equipment includes two measurement objects. One measurement object indicates the reference signal CD-SSB to be measured, a frequency point corresponding to the CD-SSB, and transmission duration of the CD-SSB. The other measurement object indicates the reference signal NCD-SSB to be measured, a frequency point corresponding to the NCD-SSB and transmission duration of the NCD-SSB. In addition, the first measurement gap configuration received by the user equipment indicates a first measurement gap length. The first measurement gap length is greater than a sum of the transmission duration of the CD-SSB, the transmission duration of the NCD-SSB and the transmission time difference between the CD-SSB and the NCD-SSB, as shown in FIG. 4.

In the embodiment described above, in a scenario where the reference signal to be measured includes the CD-SSB and the NCD-SSB, a solution where the CD-SSB and the NCD-SSB coexist is needed for measuring radio resource management (RRM). The measurement method according to the disclosure is applied to a scenario where the CD-SSB and the NCD-SSB coexist, and expands an application scenario of radio resource management (RRM) measurement.

The example of the disclosure provides a measurement method. The method is performed by user equipment. The method may be performed independently or in combination with any other example of the examples of the disclosure. FIG. 9 is a flowchart of a measurement method according to an illustrative example. As shown in FIG. 9, the method includes:

Step 901, measurement configuration information transmitted by a network device is received.

Step 902, in response to determining that the measurement gap configuration information includes second measurement gap configuration and third measurement gap configuration, a CD-SSB is measured based on the second measurement gap configuration and a NCD-SSB is measured based on the third measurement gap configuration.

The measurement configuration information includes measurement object information and measurement gap configuration information, and the measurement object information indicates that a reference signal to be measured by the user equipment includes a cell defining synchronization signal block (CD-SSB) and a non-cell defining synchronization signal block (NCD-SSB). A measurement gap length is determined based on a transmission time difference between the CD-SSB and the NCD-SSB.

In an embodiment, the network device configures a measurement configuration parameter for the user equipment. That is, the network device determines the measurement configuration information. The measurement configuration information includes the measurement object information and the measurement gap configuration information. The measurement object information includes two measurement objects, one measurement object indicates a reference signal CD-SSB to be measured, and the other measurement object indicates a reference signal NCD-SSB to be measured. The measurement gap configuration information includes measurement gap configuration. The measurement gap configuration indicates a corresponding measurement gap length, measurement gap period and measurement gap offset. The measurement gap length is determined based on the transmission time difference between the CD-SSB and the NCD-SSB. The network device transmits the measurement configuration information to the user equipment. The user equipment determines that the measurement configuration information received includes the second measurement gap configuration and the third measurement gap configuration, measures the reference signal CD-SSB based on a second measurement gap length, a second measurement gap period and a second measurement gap offset that are indicated by the second measurement gap configuration and measures the reference signal NCD-SSB based on a third measurement gap length, a third measurement gap period and a third measurement gap offset that are indicated by the third measurement gap configuration.

A set threshold may be set by the network device or agreed by a communication protocol.

As shown in FIG. 6, the user equipment measures the reference signal CD-SSB and the reference signal NCD-SSB within two different measurement gaps respectively.

In an embodiment, the measurement object information includes two measurement objects. One measurement object indicates the reference signal CD-SSB to be measured, a frequency point corresponding to the CD-SSB, and transmission duration of the CD-SSB. The other measurement object indicates the reference signal NCD-SSB to be measured, a frequency point corresponding to the NCD-SSB and transmission duration of the NCD-SSB. When the transmission time difference between the CD-SSB and the NCD-SSB is greater than the set threshold, the user equipment receives two sets of measurement gap configuration, that is, the second measurement gap configuration and the third measurement gap configuration, and measures the reference signal CD-SSB and the reference signal NCD-SSB based on the two sets of measurement gap configuration respectively.

The second measurement gap configuration indicates the second measurement gap length, the second measurement gap period, and the second measurement gap offset. The third measurement gap configuration indicates the third measurement gap length, the third measurement gap period and the third measurement gap offset.

In an example, the second measurement gap length is configured based on the transmission duration of the CD-SSB. The third measurement gap length is configured based on the transmission duration of the NCD-SSB.

In an example, the second measurement gap length is equal to the third measurement gap length, as shown in FIG. 6.

In an example, the second measurement gap period is equal to the third measurement gap period, and a difference between the second measurement gap offset and the third measurement gap offset is equal to the transmission time difference between the CD-SSB and the NCD-SSB, as shown in FIG. 6.

In the embodiment described above, in a scenario where the reference signal to be measured includes the CD-SSB and the NCD-SSB, a solution where the CD-SSB and the NCD-SSB coexist is needed for measuring radio resource management (RRM). The measurement method according to the disclosure is applied to a scenario where the CD-SSB and the NCD-SSB coexist, and expands an application scenario of radio resource management (RRM) measurement.

The example of the disclosure provides a measurement apparatus. The measurement apparatus is arranged on a network device. As shown in FIG. 10, the measurement apparatus includes:
a processing module 1001 configured to determine measurement configuration information; and
a transmitting and receiving module 1002 configured to transmit the measurement configuration information to user equipment.

The measurement configuration information includes measurement object information and measurement gap configuration information, and the measurement object information indicates that a reference signal to be measured by the user equipment includes a cell defining synchronization signal block (CD-SSB) and a non-cell defining synchronization signal block (NCD-SSB).

In a possible embodiment, the measurement gap configuration information indicates a measurement gap length, and the measurement gap length is determined based on a transmission time difference between the CD-SSB and the NCD-SSB.

In a possible embodiment, the processing module 1001 is further configured to:
determine, in response to determining that the transmission time difference is less than or equal to a set threshold, that the measurement gap configuration information includes first measurement gap configuration.

The first measurement gap configuration is configured for the user equipment to measure the CD-SSB and the NCD-SSB.

In a possible embodiment, the first measurement gap configuration indicates a first measurement gap length, and the first measurement gap length is greater than a sum of transmission duration of the CD-SSB, transmission duration of the NCD-SSB and the transmission time difference.

The measurement object information includes the transmission duration of the CD-SSB and the transmission duration of the NCD-SSB.

In a possible embodiment, the processing module 1001 is further configured to:
determine, in response to determining that the transmission time difference is greater than a set threshold, that the measurement gap configuration information includes second measurement gap configuration and third measurement gap configuration.

The second measurement gap configuration is configured for the user equipment to measure the CD-SSB, and the third measurement gap configuration is configured for the user equipment to measure the NCD-SSB.

In a possible embodiment, the second measurement gap configuration indicates a second measurement gap length, and the second measurement gap length is configured based on transmission duration of the CD-SSB.

The third measurement gap configuration indicates a third measurement gap length, and the third measurement gap length is configured based on transmission duration of the NCD-SSB.

The measurement object information includes the transmission duration of the CD-SSB and the transmission duration of the NCD-SSB.

In a possible embodiment, the second measurement gap length is equal to the third measurement gap length.

In a possible embodiment, the second measurement gap configuration indicates a second measurement gap period and a second measurement gap offset, and the third measurement gap configuration indicates a third measurement gap period and a third measurement gap offset.

The second measurement gap period is equal to the third measurement gap period, and a difference between the second measurement gap offset and the third measurement gap offset is equal to the transmission time difference.

The example of the disclosure provides a measurement apparatus. The measurement apparatus is arranged on user equipment. As shown in FIG. 11, the measurement apparatus includes:
a transmitting and receiving module 1101 configured to receive measurement configuration information transmitted by a network device.

The measurement configuration information includes measurement object information and measurement gap configuration information, and the measurement object information indicates that a reference signal to be measured by the user equipment includes a cell defining synchronization signal block (CD-SSB) and a non-cell defining synchronization signal block (NCD-SSB).

In a possible embodiment, the measurement gap configuration information indicates a measurement gap length, and the measurement gap length is determined based on a transmission time difference between the CD-SSB and the NCD-SSB.

In a possible embodiment, the apparatus further includes:
a processing module configured to measure, in response to determining that the measurement gap configuration information includes first measurement gap configuration, the CD-SSB and the NCD-SSB based on the first measurement gap configuration.

In a possible embodiment, the first measurement gap configuration indicates a first measurement gap length, and the first measurement gap length is greater than a sum of transmission duration of the CD-SSB, transmission duration of the NCD-SSB and the transmission time difference.

The measurement object information includes the transmission duration of the CD-SSB and the transmission duration of the NCD-SSB.

In a possible embodiment, the processing module is further configured to:
measure, in response to determining that the measurement gap configuration information includes second measurement gap configuration and third measurement gap configuration, the CD-SSB based on the second measurement gap configuration and measure the NCD-SSB based on the third measurement gap configuration.

In a possible embodiment, the second measurement gap configuration indicates a second measurement gap length, and the second measurement gap length is configured based on the transmission duration of the CD-SSB.

The third measurement gap configuration indicates a third measurement gap length, and the third measurement gap length is configured based on the transmission duration of the NCD-SSB.

The measurement object information includes the transmission duration of the CD-SSB and the transmission duration of the NCD-SSB.

In a possible embodiment, the second measurement gap length is equal to the third measurement gap length.

In a possible embodiment, the second measurement gap configuration indicates a second measurement gap period and a second measurement gap offset, and the third measurement gap configuration indicates a third measurement gap period and a third measurement gap offset.

The second measurement gap period is equal to the third measurement gap period, and a difference between the second measurement gap offset and the third measurement gap offset is equal to the transmission time difference.

The example of the disclosure provides a communication apparatus, which may be used as a network device. The communication apparatus includes:
a processor; and
a memory configured to store a processor-executable instruction.

The processor is configured to implement steps of the measurement method described above by executing the executable instruction in the memory.

The example of the disclosure provides a communication apparatus, which may be used as user equipment. The communication apparatus includes:
a processor; and
a memory configured to store a processor-executable instruction.

The processor is configured to implement steps of the measurement method described above by executing the executable instruction in the memory.

The example of the disclosure provides a computer-readable storage medium. The computer-readable storage medium stores an instruction, where when the instruction is called to be executed on a computer, the computer is caused to execute steps of the measurement method described above.

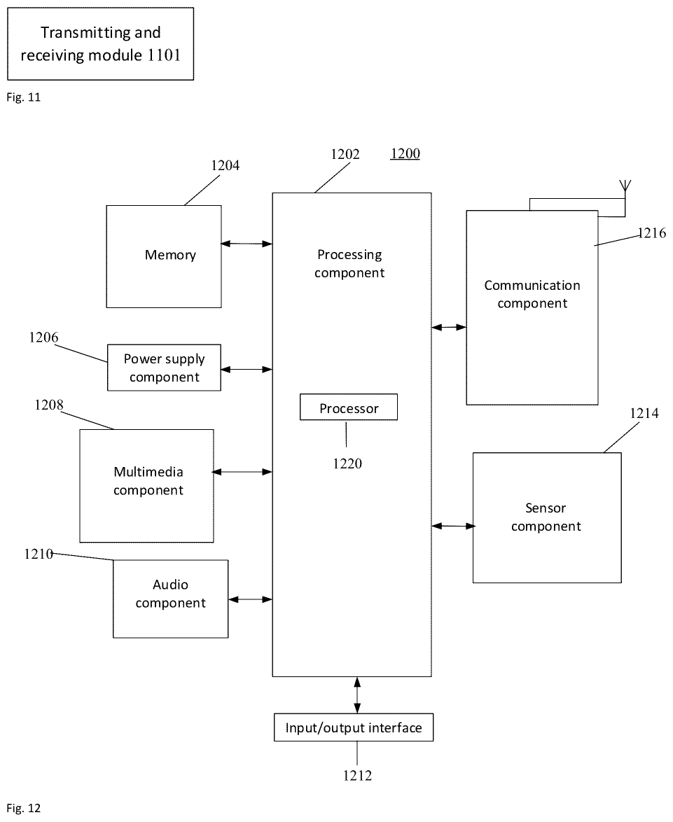

FIG. 12 is a structural diagram of a measurement apparatus 1200 according to an illustrative example. For example, the apparatus 1200 may be a mobile phone, a computer, a digital broadcast terminal, a message transceiver device, a game console, a tablet device, a medical device, a fitness device, a personal digital assistant, etc.

With reference to FIG. 12, the apparatus 1200 may include one or more of a processing component 1202, a memory 1204, a power supply component 1206, a multimedia component 1208, an audio component 1210, an input/output (I/O) interface 1212, a sensor component 1214, and a communication component 1216.

The processing component 1202 generally controls an overall operation of the apparatus 1200, such as an operation associated with display, a telephone call, data communication, a camera operation, and a recording operation. The processing component 1202 may include one or more processors 1220 for executing an instruction, and completing all or some steps of the method described above. In addition, the processing component 1202 may include one or more modules for interaction between the processing component 1202 and other components. For example, the processing component 1202 may include a multimedia module for interaction between the multimedia component 1208 and the processing component 1202.

The memory 1204 is configured to store various types of data to support the operation by the apparatus 1200. Instances of these data include instructions for any application or method operated on the apparatus 1200, contact data, phonebook data, messages, pictures, videos, etc. The memory 1204 may be implemented by any type of volatile or non-volatile storage devices or their combinations, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk and an optical disk.

The power supply component 1206 energizes various components of the apparatus 1200. The power supply component 1206 may include a power management system, one or more power supplies, and other components associated with power generation, management and distribution for the apparatus 1200.

The multimedia component 1208 includes a screen providing an output interface between the apparatus 1200 and a user. In some examples, the screen may include a liquid crystal display (LCD) and a touch panel (TP). If the screen includes the touch panel, the screen may be implemented as a touch screen to receive an input signal from the user. The touch panel includes one or more touch sensors to sense touch, swipe, and gestures on the touch panel. The touch sensor may not only sense a boundary of a touch or swipe action, but also measure duration and a pressure associated with the touch or swipe operation. In some examples, the multimedia component 1208 includes a front-facing camera and/or a rear-facing camera. When the apparatus 1200 is in an operational mode, for example, a photographing mode or a video mode, the front-facing camera and/or the rear-facing camera may receive external multimedia data. Each of the front-facing camera and the rear-facing camera may be a fixed-focus optical lens system or have a focal length and an optical zoom capacity.

The audio component 1210 is configured to output and/or input an audio signal. For example, the audio component 1210 includes a microphone (MIC). When the apparatus 1200 is in an operational mode, such as a call mode, a recording mode or a voice recognition mode, the microphone is configured to receive an external audio signal. The audio signal received may be further stored in the memory 1204 or transmitted through the communication component 1216. In some examples, the audio component 1210 further includes a speaker configured to output the audio signal.

The I/O interface 1212 provides an interface between the processing component 1202 and a peripheral interface module. The peripheral interface module may be a keyboard, a click wheel, a button, etc. These buttons may include, but are not limited to: a home button, a volume button, a start button and a lock button.

The sensor component 1214 includes one or more sensors configured to provide state assessment in various aspects for the apparatus 1200. For example, the sensor component 1214 may detect an on/off state of the apparatus 1200, and relative location of the components. For example, the components are a display and a keypad of the apparatus 1200. The sensor component 1214 may also detect a location change of the apparatus 1200 or a component of the apparatus 1200, presence or absence of contact between the user and the apparatus 1200, orientation or acceleration/deceleration of the apparatus 1200, and a temperature change of the apparatus 1200. The sensor component 1214 may include a proximity sensor configured to detect the presence of a nearby object in the absence of any physical touch. The sensor component 1214 may further include an optical sensor, such as a complementary metal-oxide-semiconductor transistor (CMOS) or charge-coupled device (CCD) image sensor for use in an imaging application. In some examples, the sensor component 1214 may further include an acceleration sensor, a gyroscope sensor, a magnetic sensor, a pressure sensor or a temperature sensor.

The communication component 1216 is configured to facilitate wired or wireless communication between the apparatus 1200 and other devices. The apparatus 1200 may access a radio network based on a communication standard, such as WiFi, the 2nd generation mobile communication technology (2G) or the 3rd generation mobile communication technology (3G), or their combinations. In an illustrative example, the communication component 1216 receives a broadcast signal or broadcast related information from an external broadcast management system via a broadcast channel. In an illustrative example, the communication component 1216 further includes a near field communication (NFC) module to promote short-range communication. For example, the NFC module may be implemented based on a radio-frequency identification (RFID) technology, an infrared data association (IrDA) technology, an ultra-wide band (UWB) technology, a Bluetooth (BT) technology, etc.

In an illustrative example, the apparatus 1200 may be implemented by one or more application specific integrated circuits (ASICs), digital signal processors (DSPs), digital signal processing devices (DSPDs), programmable logic devices (PLDs), field programmable gate arrays (FPGAs), controllers, microcontrollers, microprocessors or other electronic components for executing the method.

In an illustrative example, a non-transitory computer-readable storage medium including an instruction is further provided, such as the memory 1204 including an instruction. The instruction may be executed by the processor 1220 of the apparatus 1200 for implementing the method. For example, the non-transitory computer-readable storage medium may be a read-only memory (ROM), a random-access memory (RAM), a compact disc read-only memory (CD-ROM), a magnetic tape, a floppy disc, an optical data storage device, etc.

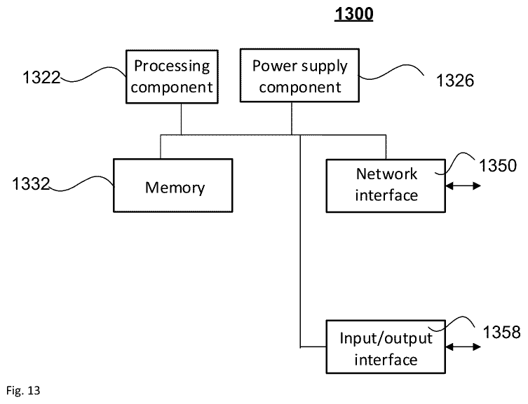

FIG. 13 is a structural diagram of a measurement apparatus 1300 according to an illustrative example. For example, the apparatus 1300 may be provided as a base station. With reference to FIG. 13, the apparatus 1300 includes a processing component 1322 and further includes one or more processors, and a memory resource represented by a memory 1332 for storing instructions, such as applications that may executed by the processing component 1322. The applications stored in the memory 1332 may include one or more modules each corresponding to a set of instructions. Further, the processing component 1322 is configured to execute the instruction, so as to execute a method for accessing an unauthorized channel.

The apparatus 1300 may further include a power supply component 1326 configured to execute power management of the apparatus 1300, a wired or wireless network interface 1350 configured to network the apparatus 1300, and an input-output (I/O) interface 1358. The apparatus 1300 may operate an operating system stored in the memory 1332, such as Windows Server™, Mac OS X™, Unix™, Linux™ and FreeBSD™.

A person of ordinary skill in the art will readily conceive of other implementation solutions of the example of the disclosure after taking into account the description and implementing the invention disclosed here. The disclosure is intended to cover any variation, use or adaptive change of the example of the disclosure, which follows general principles of the example of the disclosure and includes public general knowledge or conventional technical means in the technical field not disclosed in the disclosure. The description and the examples are merely considered illustrative, and a true scope and spirit of the disclosure are indicated by the following claims.

It should be understood that the example of the disclosure is not limited to precise structures described above and shown in the accompanying drawings, and various modifications and changes can be made without departing from the scope of the disclosure. The scope of the example of the disclosure is merely limited by the appended claims.

### INDUSTRIAL APPLICABILITY

In a scenario where the reference signal to be measured includes the CD-SSB and the NCD-SSB, a solution where the CD-SSB and the NCD-SSB coexist is needed for measuring radio resource management (RRM). The measurement method according to the disclosure is applied to a scenario where the CD-SSB and the NCD-SSB coexist, and expands an application scenario of radio resource management (RRM) measurement.

1. A measurement method, performed by a network device, comprising:
determining measurement configuration information; and
transmitting the measurement configuration information to user equipment;
wherein
the measurement configuration information comprises measurement object information and measurement gap configuration information, and the measurement object information indicates that a reference signal to be measured by the user equipment comprises a cell defining synchronization signal block (CD-SSB) and a non-cell defining synchronization signal block (NCD-SSB).

2. The measurement method according to claim 1, wherein
the measurement gap configuration information indicates a measurement gap length, and the measurement gap length is determined based on a transmission time difference between the CD-SSB and the NCD-SSB.

3. The measurement method according to claim 2, wherein the determining measurement configuration information comprises:
in response to determining that the transmission time difference is less than or equal to a set threshold, determining that the measurement gap configuration information comprises first measurement gap configuration; wherein
the first measurement gap configuration is configured for the user equipment to measure the CD-SSB and the NCD-SSB.

4. The measurement method according to claim 3, wherein
the first measurement gap configuration indicates a first measurement gap length, and the first measurement gap length is greater than a sum of transmission duration of the CD-SSB, transmission duration of the NCD-SSB and the transmission time difference; and
the measurement object information comprises the transmission duration of the CD-SSB and the transmission duration of the NCD-SSB.

5. The measurement method according to claim 2, wherein the determining measurement configuration information comprises:
in response to determining that the transmission time difference is greater than a set threshold, determining that the measurement gap configuration information comprises second measurement gap configuration and third measurement gap configuration; wherein
the second measurement gap configuration is configured for the user equipment to measure the CD-SSB, and the third measurement gap configuration is configured for the user equipment to measure the NCD-SSB.

6. The measurement method according to claim 5, wherein
the second measurement gap configuration indicates a second measurement gap length, and the second measurement gap length is configured based on transmission duration of the CD-SSB;
the third measurement gap configuration indicates a third measurement gap length, and the third measurement gap length is configured based on transmission duration of the NCD-SSB; and
the measurement object information comprises the transmission duration of the CD-SSB and the transmission duration of the NCD-SSB.

7. The measurement method according to claim 6, wherein
the second measurement gap length is equal to the third measurement gap length.

8. The measurement method according to claim 5, wherein
the second measurement gap configuration indicates a second measurement gap period and a second measurement gap offset, and the third measurement gap configuration indicates a third measurement gap period and a third measurement gap offset; and
the second measurement gap period is equal to the third measurement gap period, and a difference between the second measurement gap offset and the third measurement gap offset is equal to the transmission time difference.

9. A measurement method, performed by user equipment, comprising:
receiving measurement configuration information transmitted by a network device; wherein
the measurement configuration information comprises measurement object information and measurement gap configuration information, and the measurement object information indicates that a reference signal to be measured by the user equipment comprises a cell defining synchronization signal block (CD-SSB) and a non-cell defining synchronization signal block (NCD-SSB).

10. The measurement method according to claim 9, wherein
the measurement gap configuration information indicates a measurement gap length, and the measurement gap length is determined based on a transmission time difference between the CD-SSB and the NCD-SSB.

11. The measurement method according to claim 10, further comprising:
in response to determining that the measurement gap configuration information comprises first measurement gap configuration, measuring the CD-SSB and the NCD-SSB based on the first measurement gap configuration.

12. The measurement method according to claim 11, wherein
the first measurement gap configuration indicates a first measurement gap length, and the first measurement gap length is greater than a sum of transmission duration of the CD-SSB, transmission duration of the NCD-SSB and the transmission time difference; and
the measurement object information comprises the transmission duration of the CD-SSB and the transmission duration of the NCD-SSB.

13. The measurement method according to claim 10, further comprising:
in response to determining that the measurement gap configuration information comprises second measurement gap configuration and third measurement gap configuration, measuring the CD-SSB based on the second measurement gap configuration and measuring the NCD-SSB based on the third measurement gap configuration.

14. The measurement method according to claim 13, wherein
the second measurement gap configuration indicates a second measurement gap length, and the second measurement gap length is configured based on transmission duration of the CD-SSB;
the third measurement gap configuration indicates a third measurement gap length, and the third measurement gap length is configured based on transmission duration of the NCD-SSB; and
the measurement object information comprises the transmission duration of the CD-SSB and the transmission duration of the NCD-SSB.

15. The measurement method according to claim 14, wherein
the second measurement gap length is equal to the third measurement gap length.

16. The measurement method according to claim 13, wherein
the second measurement gap configuration indicates a second measurement gap period and a second measurement gap offset, and the third measurement gap configuration indicates a third measurement gap period and a third measurement gap offset; and
the second measurement gap period is equal to the third measurement gap period, and a difference between the second measurement gap offset and the third measurement gap offset is equal to the transmission time difference.

17-18. (canceled)

19. A communication apparatus, comprising:
one or more processors; and
a memory configured to store a processor-executable instruction; wherein
the one or more processors are collectively configured to implement steps of the measurement method according to claim 1 by executing the executable instruction in the memory.

20. A communication apparatus, comprising:
one or more processors; and
a memory configured to store a processor-executable instruction; wherein
the one or more processors are collectively configured to:
receive measurement configuration information transmitted by a network device;
wherein
the measurement configuration information comprises measurement object information and measurement gap configuration information, and the measurement object information indicates that a reference signal to be measured by the user equipment comprises a cell defining synchronization signal block (CD-SSB) and a non-cell defining synchronization signal block (NCD-SSB).

21. A non-transitory computer-readable storage medium, storing one or more programs configured to be executed by one or more processors of a computer, the one or more programs comprising instruction, wherein when the instruction is called to be executed on a computer, the computer is caused to execute steps of the measurement method according to claim 1.

22. A non-transitory computer-readable storage medium, storing one or more programs configured to be executed by one or more processors of a computer, the one or more programs comprising instruction, wherein when the instruction is called to be executed on a computer, the computer is caused to execute steps of the measurement method according to claim 9.
